(19) United States
(12) Patent Application Publication
(10) Pub. No.: US 2009/0322285 A1
(43) Pub. Date: Dec. 31, 2009

(54) Method and Apparatus for Wireless Charging Using a Multi-Band Antenna

(75) Inventor: Jukka Olavi Hautanen, Tampere (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/146,033

(22) Filed: Jun. 25, 2008

(51) Int. Cl. H02J 17/00; H01Q 9/04; H02J 7/00

(52) U.S. Cl. 320/137; 343/700 MS; 307/149

(57) ABSTRACT

In accordance with an example embodiment of the present invention, a multi-band antenna is configured to receive signal information at a signal frequency and electric power at an energy frequency.

### TECHNICAL FIELD

The present application relates generally to wireless charging using a multi-band antenna.

### BACKGROUND

Global System for Mobile communication (GSM) based mobile communication typically operates on different GSM communication frequencies, such as 900 MHz, 1.8 GHz or at times a related communication frequency of 1.9 GHz. Antennas receive signal information over the different GSM frequencies to facilitate mobile communication. Although antennas may be used for mobile communication, antennas are still limited.

### SUMMARY

Various aspects of the invention are set out in the claims.

In accordance with an example embodiment of the present invention, a multi-band antenna is configured to receive signal information at a signal frequency and electric power at an energy frequency.

### BRIEF DESCRIPTION OF THE DRAWINGS

For a more complete understanding of example embodiments of the present invention, the objects and potential advantages thereof, reference is now made to the following descriptions taken in connection with the accompanying drawings in which:

FIG. 1A depicts a top view of a charging cradle and an electronic device operating in accordance with example embodiments of the invention;

FIG. 1B depicts a side view of the electronic device and charging cradle of FIG. 1A according to an example embodiment of the invention;

FIG. 1C is a top view of a charging cradle and an electronic device operating in accordance with example embodiments of the invention;

FIG. 1D is a top view of a charging cradle, a base station, and an electronic device operating in accordance with example embodiments of the invention;

FIG. 1E depicts a dielectric material transferring electric power to an antenna in accordance with an example embodiment of the invention;

FIG. 2 is a top view of an example multi-band antenna coupled to an electronic device in accordance to example embodiments of the invention;

FIG. 3A depicts a side view of a Dielectric Resonator Antenna (DRA) operating in accordance with an example embodiment of the invention;

FIG. 3B depicts a top view of the Dielectric Resonator Antenna of FIG. 3A in accordance with an example embodiment of the invention;

FIG. 4 depicts an antenna operating at one or more of at least three different resonant frequencies according to an example embodiment of the invention;

FIG. 5 depicts an example antenna configured to receive and process signal information and electric power in accordance with an example embodiment of the invention; and

FIG. 6 is a flow diagram illustrating a process for applying electric power to a battery in accordance with example embodiments of the invention.

### DETAILED DESCRIPTION OF THE DRAWINGS

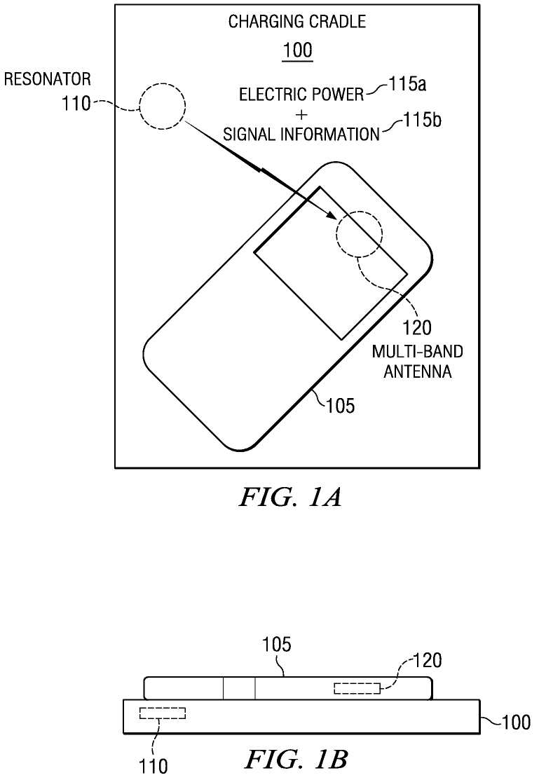

An example embodiment of the present invention and its potential advantages are best understood by referring to FIGS. 1A through 6 of the drawings.

FIG. 1A depicts a top view of a charging cradle 100 and an electronic device 105 operating in accordance with example embodiments of the invention. An example embodiment of the invention comprises an electronic device 105 coupled to the charging cradle 100. In the example embodiment, the charging cradle 100, e.g., a power source, comprises a resonator 110, such as a dielectric resonator or the like, configured to transmit electric power 115a over an energy frequency. In an embodiment, the charging cradle 100 may also be configured to transmit signal information 115b over a signal frequency. For example, the resonator 110 may employ techniques known in the art, such as broadcasting electric power 115a at a low-power radio (RF) signal, to transmit the electric power 115a and the signal information 115b over the energy frequency and signal frequency respectively. In an alternative embodiment, the resonator 110 is configured to transmit electric power 115a and a base station or other suitable transmitter, such as a local base station, e.g., Local Area Network, is configured to transmit the signal information 115b.

In an embodiment, a multi-band antenna 120 of electronic device 105 is used to receive the electric power 115a and signal information 115b. For example, a multi-band antenna 120 of electronic device 105, such as a Dielectric Resonator Antenna (DRA), a Planar Inverted-F type antenna, Inverted F antenna, or ceramically loaded antenna, is configured to receive the electric power 115a and signal information 115b, via a single multi-band antenna. In an embodiment, the electronic device 105 is configured to apply the electric power 115a to a battery or other power source. In an embodiment, the electronic device 105 is further configured to apply the electric power 115a to a battery or other power source and process the signal information 115b.

Consider the following example; the electronic device 105 may receive electric power 115a at an energy frequency, such as 1500 MHz and the signal information 115b, at a signal frequency, i.e., 800 MHz. The electronic device 105 may route and apply the electric power 115a to a battery as described below. In an alternative embodiment, the electronic device 105 may also process the signal information 115b. It should be understood that the electronic device 105 may process the signal information using a GSM circuit or other techniques known in the art. In this way, the example embodiment may use a multi-band antenna to receive electric power 115a and signal information 115b to a charge an electronic device 105 battery and provide mobile communications.

FIG. 1B depicts a side view of the electronic device 105 and charging cradle 100 of FIG. 1A according to an example embodiment of the invention. An example embodiment comprises an electronic device 105 having the multi-band antenna 120 and a charging cradle 100 with a resonator 110. It should be understood that the electronic device 105 may be separate from the charging cradle 100. For example, the electronic device 105 may be in communication with the charging cradle 100 to receive the electric power 115a and a base station to receive the signal information 115b. It should be further understood that the electronic device 105 may be a mobile communications device, personal digital assistant (PDA), cell phone, pager, laptop computer, palmtop computer, or the like. The electronic device may also be an integrated component of a vehicle, such as an automobile, bicycle, airplane or other mobile conveyance.

FIG. 1C is a top view of a charging cradle 100 and an electronic device 105 operating in accordance with example embodiments of the invention. An example embodiment comprises an electronic device 105 in communication with the charging cradle 100 over a communications path 125. In an embodiment, the charging cradle 100 comprises a resonator 110 configured to transmit electric power 115a and signal information 115b, over the communications path 125, using multiple frequencies. In an embodiment, the electronic device 105 is configured to receive the electric power 115a and signal information 115b, via a multi-band antenna, and to apply the electric power 115a and process the signal information 115b.

For example, the electronic device 105 may receive electric power 115a at an energy frequency, such as 1400 MHz and the signal information 115b, at a signal frequency, i.e., 900 MHz. In an embodiment, the electronic device 105 may route and apply the electric power 115a to a battery. In an alternative embodiment, the electronic device 105 also processes the signal information 115b. Further, the electronic device 105 processes the signal information 115b using a GSM circuit or other techniques known in the art. In this way, example embodiments may use a multi-band antenna, which is separate from the carrying cradle 100 to receive electric power 115a and signal information 115b to a charge an electronic device 105 battery and provide mobile communications.

It should be understood that each frequency described throughout the description are merely examples and any number of frequencies and variations may be employed using example embodiments of the invention.

FIG. 1D is a top view of a charging cradle 100, a base station 150, and an electronic device 105 operating in accordance with example embodiments of the invention. In particular, FIG. 1D shows an example embodiment with an electronic device 105 in communication with the charging cradle 100 over an energy frequency communications path 125a. The electronic device 105 may also be in communication with a base station 150 over a signal frequency 125b. In an embodiment, the charging cradle 100 may comprise a resonator 110 configured to transmit electric power 115a. In an embodiment, the base station 150 is configured to send signal information 115b. In an example embodiment, the electronic device 105 is configured to receive the electric power 115a and signal information 115b, via a multi-band antenna, and to apply the electric power 115a and process the signal information 115b.

For example, the electronic device 105 may receives the electric power 115a from the resonator 110 at an energy frequency, such as 1400 MHz and the signal information 115b, at a signal frequency, i.e., 900 MHz. In an embodiment, the electronic device 105 may route and applies the electric power 115a to a battery as described below. In an alternative embodiment, the electronic device 105 may also process the signal information 115b received from the base station 150. Further, the electronic device 105 may process the signal information using a GSM circuit or other techniques known in the art. The example embodiment uses a multi-band antenna, which is separate from the carrying cradle 100 and the base station 150 to receive electric power 115a and signal information 115b to a charge an electronic device 105 battery and provide mobile communications.

It should be understood that the base station 150 of FIG. 1D may operate using a Wireless Wide Area Network (WWAN) protocol operating, for example, under a cellular telephone network protocol, or may operate using a wireless local area network (WLAN) or Local Area Network (LAN) protocol or a Wireless Personal Area Network (WPAN) protocol. Use of other protocols is also possible. It should be further understood that example embodiments may use the carrying cradle 100 or the base station 150 to transmit signal information. The electronic device 105 is configured to receive the electric power 115a and signal information 115b from any number of sources.

Moreover, an electronic device may communicate in a wireless network that may be a wireless personal area network (WPAN) operating, for example, under the Bluetooth or IEEE 802.15 network protocol. The wireless network may be a wireless local area network (WLAN) operating, for example under the IEEE 802.11, Hiperlan, WiMedia Ultra Wide Band (UWB), WiMax, WiFi, or Digital Enhanced Cordless Telecommunications (DECT) network protocol. Or, the wireless network may be a wireless wide area network (WWAN) operating, for example, under a cellular telephone network protocol, for example Global System for Mobile (GSM), General Packet Radio Service (GPRS), Enhanced Data rates for GSM Evolution (EDGE), Code Division Multiple Access (CDMA), Universal Mobile Telecommunications System (UMTS) and CDMA2000.

FIG. 1E depicts a dielectric material 150 transferring electric power 155 to an antenna 160 in accordance with an example embodiment of the invention. In this example embodiment, the dielectric material 150 broadcasts electric power 155, such as a low-power radio (RF) signal, at a specified energy frequency. In an embodiment, the antenna 160 is configured to receive the electric power 155 to charge or recharge a battery at the specified energy frequency. Thus, the broadcasting of electric power 155 may allow the antenna 160 to receive and apply the electric power 155 to a battery. Other techniques for transmitting energy or electric power 155 as known in the art may also be performed.

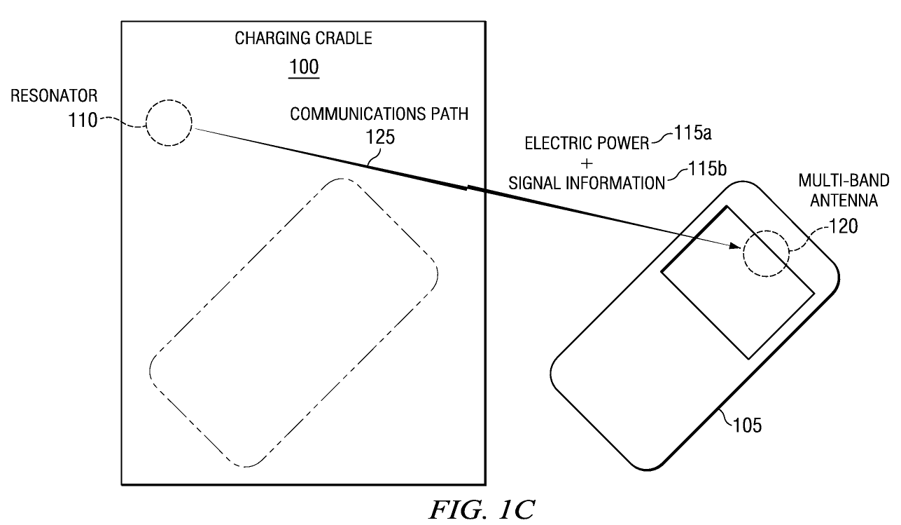

FIG. 2 is a top view of an example multi-band antenna 210 coupled to an electronic device in accordance to example embodiments of the invention. In an embodiment, the multi-band antenna 210 comprises a first radiating arm 212 and a second radiating arm 214 that are both coupled to a feeding port 217 through a common conductor 216. Further, the multi-band antenna 210 may also comprise a substrate material 218 on which the antenna structure 212, 214, 216 is fabricated, such as a dielectric substrate, a flex-film substrate, or some other type of suitable substrate material. In an embodiment, the antenna structure 212, 214, 216 may be patterned from a conductive material, such as a metallic thick-film paste that is printed and cured on the substrate material 218, but may alternatively be fabricated using other known fabrication techniques.

In an embodiment, the first radiating arm 212 comprises a meandering section 220 and an extended section 222. Further, the meandering section 220 may be coupled to and extends away from the common conductor 216. The extended section 222 may also be contiguous with the meandering section 220 and extends from the end of the meandering section 220 back towards the common conductor 216. In the example embodiment, the meandering section 220 of the first radiating arm 212 is formed into a geometric shape known as a space-filling curve, in order to reduce the overall size of the antenna 210. In an embodiment, a space-filling curve is characterized by at least ten segments which are connected so each segment forms an angle with its adjacent segments, that is, no pair of adjacent segments define a larger straight segment. It should be understood, however, that the meandering section 220 may comprise other space-filling curves than that shown in FIG. 2, or may optionally be arranged in an alternative meandering geometry.

In an embodiment, the second radiating arm 214 comprises three linear portions. For example, the first linear portion extends in a vertical direction away from the common conductor 216. The second linear portion extends horizontally from the end of the first linear portion towards the first radiating arm. The third linear portion extends vertically from the end of the second linear portion in substantially the same direction as the first linear portion and adjacent to the meandering section 220 of the first radiating arm 214.

In an embodiment, the common conductor 216 of the multi-band antenna 210 couples the feeding port 217 to the first and second radiating arms 212, 214. Further, the common conductor 216 may extend horizontally beyond the second radiating arm 214, and may be folded in a perpendicular direction in order to couple the feeding port 217 to communications circuitry in an electronics device.

In an example embodiment, the first and second radiating arms 212, 214 are each tuned to a different frequency band, resulting in a multi-band antenna. For example, the antenna 210 may be tuned to the desired dual-band operating frequencies of a mobile communications device by pre-selecting the total conductor length of the radiating arm 212. Further, the antenna 210 may be tuned to the desired dual-band energy frequency by pre-selecting the total conductor length of the radiating arm 214. For example, in this example embodiment, the first radiating arm 212 may be tuned to operate in a signal frequency, e.g., lower frequency band, or groups of bands, such as Code Division Multiple Access (CDMA) at 800 MHz, Global System for Mobile communication (GSM) at 850 MHz, GSM at 900 MHz, Global Positioning System (GPS), Universal Mobile Telecommunications System (UMTS), or some other desired signal frequency band.

In an embodiment, the second radiating arm 214 may be tuned to operate in an energy frequency, e.g., a higher frequency band, or group of bands, such as 1500 MHz, 1800 MHz 1900 MHz, 2.4 GHz, or some other desired energy frequency band. In an alternative embodiment, the first radiating arm 212 may be tuned to operate in an energy frequency, which comprises higher frequency band or groups of bands, to receive the electric power and the second radiating arm 214 may be tuned to operate in a signal frequency, which comprises a lower frequency band to receive signal information. In yet another alternative embodiment, frequency bands of interest to receive signal information or electric power may comprise 1710 to 1990 MHz and 2110 to 2200 MHz.

For example, the first radiating arm 212 receives signal information, such as GSM, at 800 MHz and the second radiating arm 214 receives electric power at 1500 MHz over an energy frequency. The example embodiment routes and applies the electric power to a battery based on an energy frequency as described below. In an embodiment, the GSM information in the signal information is also processed using mobile communication techniques known in the art. In this way, the example embodiment may use the multi-band antenna 210 to receive mobile communications, e.g., signal information, and electric power to a charge an electronic device battery and provide mobile communications.

It should also be understood that the multi-band antenna 210 may be expanded to comprise further frequency bands by adding additional radiating arms. For example, a third radiating arm could be added to the antenna 210 to form a tri-band antenna. It should be further understood that the antenna of FIG. 2 may also be a Dielectric Resonator Antenna (DRA), a Planar Inverted-F type antenna, Inverted F antenna, or ceramically loaded antenna.

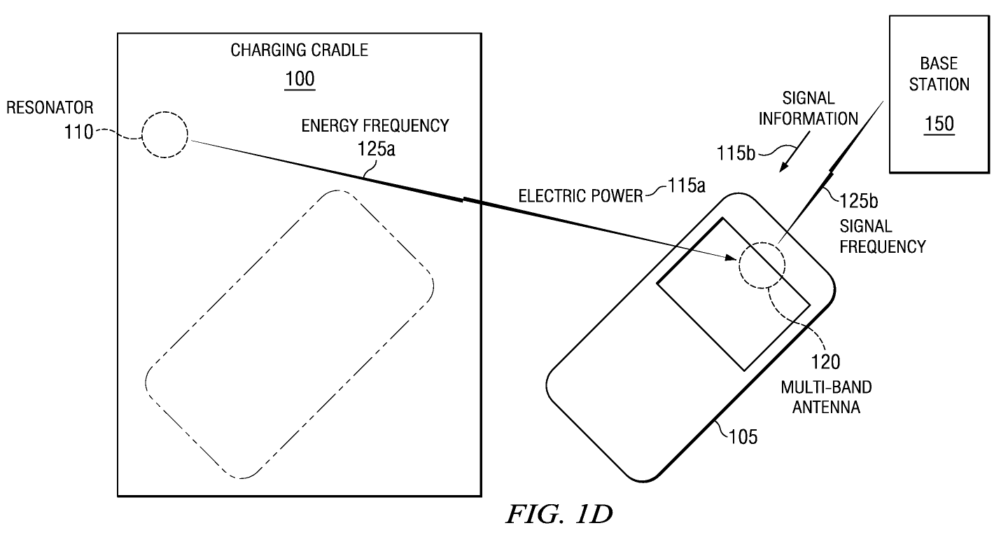

FIG. 3A depicts a side view of a Dielectric Resonator Antenna (DRA) 300 operating in accordance with an example embodiment of the invention. In the example embodiment, the DRA 300 comprises a substrate 305 having a copper sheet 310 on upper surface of the substrate 305. Further, the copper sheet 310 may comprise two slots resonant 315a, 315b at a frequency of interest. In an embodiment, a dielectric resonator 320 is placed on top of the copper sheet 310 covering part of the two slots resonant 315a, 315b.

FIG. 3B depicts a top view of the Dielectric Resonator Antenna 300 of FIG. 3A in accordance with an example embodiment of the invention. In an embodiment, FIG. 3B depicts a slotted antenna etched into a copper surface 310 located on the upper surface 330 of the substrate 310 sandwiched between the dielectric resonator 320 and the substrate 310. In an alternative embodiment, the copper sheet 310 may be a planar copper sheet and is placed on a lower surface of the substrate 310 or embedded inside the substrate. In another alternative embodiment, a Planar Inverted-F (type) Antenna (PIFA) may be placed on top of the dielectric block and a ground plane may be placed beneath the dielectric block.

In an embodiment, the DRA 300 may use dielectric material mounted on the copper sheet 310 to receive the radiation signals from a resonator, such as resonator 110 of FIG. 1A. For example, the radiation signals may comprise multiple frequencies, e.g., for signal information and/or electric power. In an example embodiment, the DRA 300 may comprise a radius of 8.8 mm 0.1 and height 26.8 mm 0.3 with 0.329, where the free space wavelength at the center frequency is 3.5 GHz. Further, the DRA 300 comprises a dielectric constant equal to 12 and is excited by an off center coaxial probe. In an embodiment, the coaxial probe has a height of 7 mm and radius 0.2 mm. The coaxial probe is located at a distance 7 millimeters away from the center of the dielectric resonator 320. a

In an embodiment, the matching frequency band for receiving signals with the DRA 300 may be from 3.04 GHz to 3.98 GHz with an impedance bandwidth of 10 dB and the resonant modes comprise between 3.26 GHz and 3.93 GHz. The resonant mode, for example, may use a signal frequency with the lower resonant frequency configured to receive signal information, such as GSM. In an embodiment, the energy frequency may comprise a higher resonant frequency configured to receive electric power from the dielectric resonator 320. It should be understood that the signal information and electric power may be received and radiated at any frequency and the above frequencies are merely for illustrative purposes.

It should be understood that by using the DRA 300 many advantages may be gained. In particular, DRAs are light weight, low cost, small size, and have an ease of integration with other active or passive Microwave Integrated Circuit (MIC) components. Moreover, DRAs may overcome limitation of patch antennas, such as the high-conductor losses at millimeter-wave frequencies, sensitivity to tolerances, and/or narrow bandwidth. Other advantages are also realized.

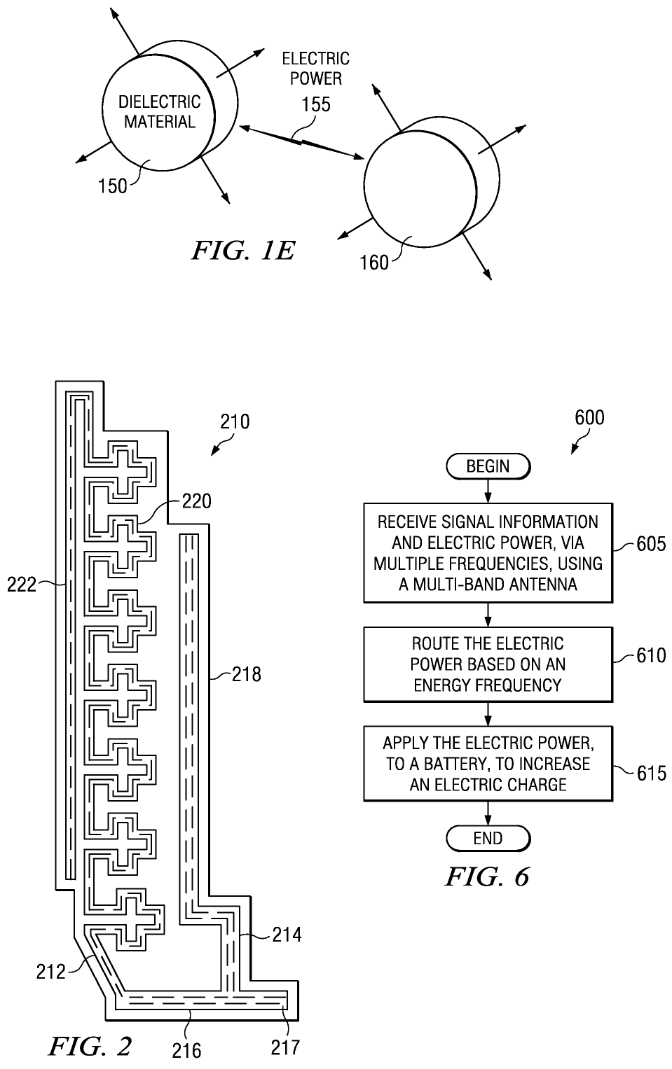

FIG. 4 depicts an antenna 410 operating at one or more of at least three different resonant frequencies according to an example embodiment of the invention. In an example embodiment, the antenna 410 may comprise three arcuate proximate conductive segments 412, 414 and 416, where a material of each segment comprises conductive material. Further, a conductive bridge 418 connects the segments 412 and 414, and a conductive bridge 420 connects the segments 414 and 416. In an embodiment, a conductive segment 417, comprising subsegments 417A, 417B and 417C, is electrically connected to and extends from the strip 414. It should be understood that although FIG. 4 depicts the segments 412, 414 and 416 as having the same general curvature or radius, this is not required by the embodiments of the invention. For example, an electrical length of each of the conductive segments of the antenna may be longer than a physical length of the segment due to the coupling between the segments.

In an embodiment, a signal terminal 421 of the antenna 410 is connected to a signal source 422 of a communications device when operative in the transmitting mode. In the receiving mode, for example, the received signal is fed to receiving circuitry of the communications device from the signal terminal 421. Although the signal terminal 421 is located at a single point in FIG. 4, the signal terminal may be shifted to other locations on the antenna structure.

In an embodiment, the antenna 410 is connected to a ground plane 424, which typically comprises a ground plane in the communications device, via a conductive element 425 extending from a ground terminal 426. In another embodiment, the ground terminal 426 may be moved to another location on the antenna 410. In an alternative embodiment, the antenna 410, for example, an Inverted F-Antenna (IFA) may not comprise a ground connection.

In an embodiment, the segment 417 comprises a reversed C-shaped segment with the subsegment 417A connected to the segment 414 and the subsegment 417C connected to ground at the ground terminal 426. Although the segment 417 may appear physically shorter than the segment 416, an electrical length of the segment 417 may be longer than an electrical length of the segment 416. In an embodiment, this difference in electrical lengths is attributable to operation of the segment 416 as a quarter-wave monopole and operation of the segment 417 as a portion of a loop antenna or a PIFA antenna (planar inverted F-shaped antenna).

In one embodiment the antenna 410 is resonant in three spaced-apart frequency bands, i.e., a tri-band antenna comprising: a signal frequency band (f1) of 824 894 MHz for Code Division Multiple Access (CDMA) communications, a second signal frequency band (f2) of 1.575 GHz GSM communications, and an energy frequency band (f3) of 2.63 2.65 GHz for electric power or energy. In an embodiment, a length of the various segments and a distance between segments are selected to provide an antenna resonant condition at the desired operating frequencies. For example, the distance between segments determines a parasitic capacitance or capacitive coupling between the segments, which affects the effective length of the segments and thus the segment resonant frequency. For example, the distance 434 is directly related to the highest resonant frequency f3, e.g., as the distance 434 increases, the resonant frequency f3 increases and vice versa. In an embodiment, the segments 412, 414, 418 cooperate to provide a resonant condition at the lowest frequency f1, the segment 416 is resonant at the highest frequency f3 and the segment 417 is resonant at the intermediate frequency f2.

In an embodiment, an electronic device, such as electronic device 105 of FIG. 1A, is operable with the antenna 410. In an embodiment, the electronic device may be capable of receiving signal information and energy. In one embodiment, a resonator sends signal information to the electronic device at a signal frequency of, for example, 2.64 GHz with right-hand circular polarization. Further, the resonator may also send electric power at 12 GHz. For example, the electronic device receives two separate communications, one with signal information and the second with electric power. In other embodiments, the signal information is transmitted by a base station or other transmitter. It should be understood that the electronic device employing embodiments of the invention may apply the electric power to charge a battery on the electronic device. Other embodiments may also process the signal information.

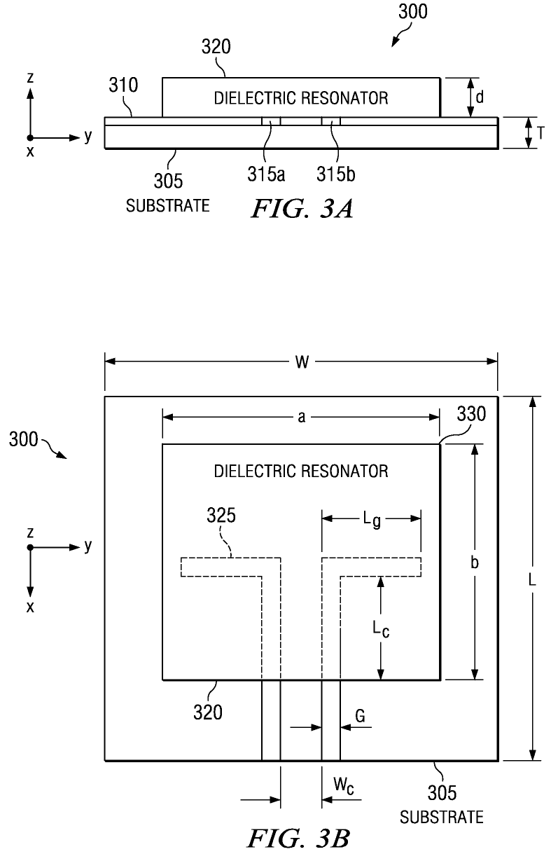

FIG. 5 depicts an example antenna 505 configured to receive and process signal information and electric power in accordance with an example embodiment of the invention. In the example embodiment, the antenna 505 is coupled to an electronic device and comprises a specified resonance frequency. For example, the antenna 505 has the same resonance frequency as a charging cradle. In an embodiment, the antenna 505 may be configured to receive signal information and electric power or energy, over the resonance frequency, via a charging cradle or other source. In an embodiment, an antenna routing system 510 routes the electric power and/or and the signal information based on respective frequencies. For example, the signal information may be GSM or Universal Mobile Telecommunications System (UMTS) signal information.

In an embodiment, the antenna routing system 510 may be configured to detect a signal frequency, such as 800 MHz, and sends the signal information to a mobile communication circuit, such as GSM or UMTS circuits 515a-d. In an embodiment, the mobile communication circuits may be configured to process the signal information. For example, the GSM or UMTS circuits 515a-d may process the signal information by sending the signal to the UMTS/GSM baseband interface circuitry 530 and the UMTS or GSM signal processing circuitry 535, 540 as appropriate. It should be understood that techniques for processing signal information are varied and any technique known in the art may be employed.

Continuing with the example embodiment, the antenna routing system 510 may also be configured to route an energy frequency, such as 1500 MHz, e.g., frequency for electric power, to the charging management circuit 520. Further, the charging management circuit 520 may be configured to apply the electric power to a battery 525, e.g., to increase an electric charge. In the example embodiment, the charging management circuit 520 is configured to apply the electric power to the battery 525 until the battery 525 charge is full or otherwise reached a desired level. Thus, the example embodiment may receive electric power and/or signal information, route the electric power and/or signal information using a single multi-band antenna, such as antenna 505.

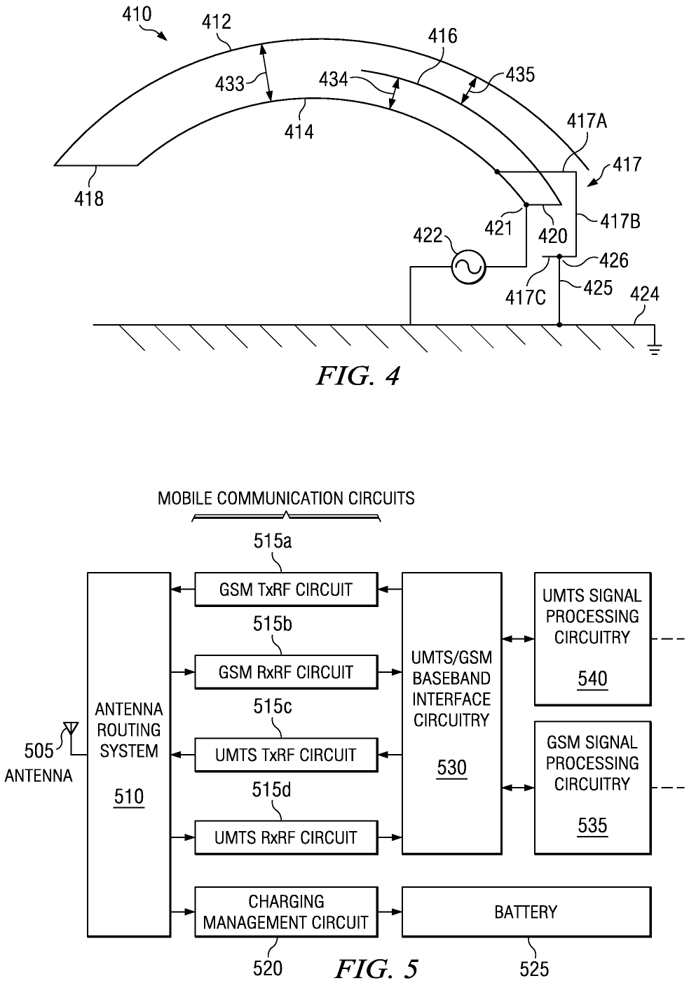

FIG. 6 is a flow diagram illustrating an example process 600 for applying electric power to a battery in accordance with example embodiments of the invention. An electronic device may be configured to use the example process 600. For example, the electronic device may receive signal information and electric power, via an energy frequency and a signal frequency, using a multi-band antenna at 605. After receiving the signal information and electric power, the electronic device may routes the electric power based on an energy frequency at 610. At 615, the process 600 applies the electric power to a battery.

In one embodiment, the electronic device of the example process 600 may also process the signal information on a signal frequency to allow mobile communications. In this way, electronic device may charge a battery and provide mobile communications via a multi-band antenna. In an embodiment, the electronic device may be a Dielectric Resonator antenna. In another embodiment, the electronic device may be Planar Inverted-F type antenna. In yet another embodiment, the electronic device may be a ceramically loaded antenna. In still yet another embodiment, the electronic device may locate the antenna in a cradle. In yet still another embodiment, the electronic device may be use a same resonant frequency to communicate between a cradle and the antenna.

It should be understood that the frequencies described above, such as GSM and WCDMA, are merely for illustrative purposes and other frequencies may be used. For example, the frequency bands and protocols may comprise (but are not limited to) AM radio (0.535-1.705 MHz); FM radio (76-108 MHz); Bluetooth (2400-2483.5 MHz); WLAN (2400-2483.5 MHz); HLAN (5150-5850 MHz); GPS (1570.42-1580.42 MHz); US-GSM 850 (824-894 MHz); EGSM 900 (880-960 MHz); EU-WCDMA 900 (880-960 MHz); PCN/DCS 1800 (1710-1880 MHz); US-WCDMA 1900 (1850-1990 MHz); WCDMA 2100 (Tx: 1920-1980 MHz Rx: 2110-2180 MHz); PCS1900 (1850-1990 MHz); UWB Lower (3100-4900 MHz); UWB Upper (6000-10600 MHz); DVB-H (470-702 MHz); DVB-H US (1670-1675 MHz); DRM (0.15-30 MHz); Wi Max (2300-2400 MHz, 2305-2360 MHz, 2496-2690 MHz, 3300-3400 MHz, 3400-3800 MHz, 5250-5875 MHz); DAB (174.928-239.2 MHz, 1452.96-1490.62 MHz); RFID LF (0.125-0.134 MHz); RFID HF (13.56-13.56 MHz); RFID UHF (433 MHz, 865-956 MHz, 2450 MHz).

It should be further understood that example embodiments of the invention may use any number of antennas, such as a Dielectric Resonator Antenna (DRA), a Planar Inverted-F type antenna, an Inverted F antenna, ceramically loaded antenna, and/or the like.

Without in any way limiting the scope, interpretation, or application of the claims appearing below, it is possible that a technical effect of one or more of the example embodiments disclosed herein may be wireless charging and signal processing in an electronic device. Another possible technical effect of one or more of the example embodiments disclosed herein may be providing a light weight, low cost, small size, and have an ease of integration with other active or passive microwave integrated circuit (MIC) components. Another technical effect of one or more of the example embodiments disclosed herein may be overcome limitations of patch antennas, such as the high-conductor losses at millimeter-wave frequencies, sensitivity to tolerances, and/or narrow bandwidth.

Embodiments of the present invention may be implemented in software, hardware, application logic or a combination of software, hardware and application logic. The software, application logic and/or hardware may reside on an electronic device or carrying cradle. If desired, part of the software, application logic and/or hardware may reside on a carry cradle and part of the software, application logic and/or hardware may reside on an electronic device. The application logic, software or an instruction set is preferably maintained on any one of various conventional computer-readable media. In the context of this document, a “computer-readable medium” may be any media or means that may contain, store, communicate, propagate or transport the instructions for use by or in connection with an instruction execution system, apparatus, or device.

If desired, the different functions discussed herein may be performed in any order and/or concurrently with each other. Furthermore, if desired, one or more of the above-described functions may be optional or may be combined.

Although various aspects of the invention are set out in the independent claims, other aspects of the invention comprise any combination of features from the described embodiments and/or the dependent claims with the features of the independent claims, and not solely the combinations explicitly set out in the claims.

It is also noted herein that while the above describes exemplifying embodiments of the invention, these descriptions should not be viewed in a limiting sense. Rather, there are several variations and modifications which may be made without departing from the scope of the present invention as defined in the appended claims.

What is claimed is:

1. A method, comprising:
receiving signal information and electric power using a multi-band antenna.

2. The method of claim 1 further comprising routing the electric power based on an energy frequency.

3. The method of claim 1 further comprising routing the signal information based on a signal frequency.

4. The method of claim 1 further comprising receiving signal information at a lower frequency than the electric power.

5. The method of claim 1 further comprising receiving signal information at a higher frequency than the electric power.

6. The method of claim 1 further comprising receiving signal information from a base station.

7. The method of claim 1 further comprising receiving electric power from a power source.

8. The method of claim 1 further comprising applying the electric power to a battery.

9. The method of claim 1 further comprising:
applying the electric power to a battery; and
processing the signal information.

10. The method of claim 1 wherein the multi-band antenna is a dielectric resonator antenna.

11. The method of claim 1 wherein the multi-band antenna is ceramically loaded.

12. The method of claim 1 wherein the multi-band antenna is located in a cradle.

13. The method of claim 1 wherein the multi-band antenna is a Planar Inverted-F type antenna.

14. The method of claim 1 wherein the multi-band antenna is an Inverted F antenna.

15. The method of claim 1 wherein the signal information comprises at least one of the following: Code Division Multiple Access (CDMA), Global System for Mobile communication (GSM), Global System for Mobile communication Global Positioning System (GPS), or Universal Mobile Telecommunications System (UMTS).

16. A apparatus, comprising:
a multi-band antenna configured to receive signal information at a signal frequency and electric power at an energy frequency.

17. The apparatus of claim 16 further comprising:
an antenna routing system configured to route the electric power based on the energy frequency.

18. The apparatus of claim 16 further comprising:
an antenna routing system configured to route the signal information based on the signal frequency.

19. The apparatus of claim 16 wherein the multi-band antenna is further configured to:
receive signal information at a lower frequency than the electric power.

20. The apparatus of claim 16 wherein the multi-band antenna is further configured to:
receive signal information at a higher frequency than the electric power.

21. The apparatus of claim 16 wherein the multi-band antenna is further configured to:
receive signal information from a base station.

22. The apparatus of claim 16 wherein the multi-band antenna is further configured to:
receive electric power from a power source.

23. The apparatus of claim 16 further comprising:
a charging management circuit configured to apply the electric power to a battery.

24. The apparatus of claim 16 further comprising:
a charging management circuit configured to apply the electric power to a battery; and
a mobile communication circuit configured to process the signal information.

25. The apparatus of claim 16 wherein the multi-band antenna is a dielectric resonator antenna.

26. The apparatus of claim 16 wherein the multi-band antenna is ceramically loaded.

27. The apparatus of claim 16 wherein the multi-band antenna is located in a cradle.

28. An electronic device comprising the apparatus of claim 16.

29. The apparatus of claim 16 wherein the multi-band antenna is a Planar Inverted-F type antenna.

30. The apparatus of claim 16 wherein the multi-band antenna is an Inverted F antenna.

31. The apparatus of claim 16 wherein the signal information comprises at least one of the following: Code Division Multiple Access (CDMA), Global System for Mobile communication (GSM), Global System for Mobile communication Global Positioning System (GPS), or Universal Mobile Telecommunications System (UMTS).

32. A computer program product comprising a computer-readable medium bearing computer program code embodied therein for use with a computer, the computer program code comprising:
code for receiving signal information and electric power using a multi-band antenna.

33. The computer program product of claim 32 further comprising:
code for routing the electric power based on an energy frequency.

34. The computer program product of claim 32 further comprising:
code for routing the signal information based on a signal frequency.

35. The computer program product of claim 32 further comprising:
code for applying the electric power to a battery.

36. The computer program product of claim 32 further comprising:
code for applying the electric power to a battery; and
code for processing the signal information.

37. A computer-readable medium encoded with instructions that, when executed by a computer, perform:
receiving signal information and electric power using a multi-band antenna.

38. The computer-readable medium of claim 37 further comprising:
routing the electric power based on an energy frequency.

39. The computer program product of claim 37 further comprising:
routing the signal information based on a signal frequency.

40. The computer-readable medium of claim 37 further comprising:
applying the electric power to a battery.

41. The computer-readable medium of claim 37 further comprising:
applying the electric power to a battery; and
processing the signal information.
